(19) United States
(12) Patent Application Publication
(10) Pub. No.: US 2003/0213861 A1
(43) Pub. Date: Nov. 20, 2003

(54) Crusher wear components

(76) Inventors: Gary J. Condon, Irwin, PA (US); Eric V. Gentis, Greensburg, PA (US); Daniel C. Zimmerman, Greensburg, PA (US)

Correspondence Address: Kevin P. Weldon, Kennametal Inc., P.O. Box 231, Latrobe, PA, 15650, US

(21) Appl. No.: 10/146,368

(22) Filed: May 15, 2002

(51) Int. Cl. B02C 19/00

(52) U.S. Cl. 241/275

(57) ABSTRACT

The present invention is particularly, but not exclusively, useful for reducing wear of component parts of impact crushers caused by earth aggregate flows during operation of impact crushers. The present invention includes a central feed body that has hard material rods fixed therein to reduce wear. The hard material rods extend above a top surface of the central feed body. The exposed top surface of the central feed body is impregnated with a plurality of cemented carbide particles. The cemented carbide particles form an upper composite matrix that helps to reduce wear and the premature wash out of the hard material rods integrally cast within the central feed body.

### BACKGROUND OF THE INVENTION

Regardless of the precise nature or function of an apparatus in which components are subjected to wear by a material flow, wear causes need for repair and replacement of components and delays in use of the apparatus while one or more worn components are identified, inspected, removed, and replaced. Wear of components adds to the expense of maintaining and operating the apparatus.

As a result of persistent wear caused by material flows, components on construction equipment exposed to material flow must be replaced. Replacements of components causes “down time” to repair, refit, and replace components. Additional expenses are associated with replacing the worn part or component, inventorying replacement components, and delivering a replacement component to what is often a remote site.

For example, a wide variety of impact crushers are used in commerce to reduce the size of larger earth materials to smaller sized aggregate. The construction industry trades employ a variety of impact crushers to reduce large aggregate to aggregate sizes and shapes required to satisfy construction specifications for mixtures and admixtures of aggregate with cement and other ingredients and for further processing of size reductions, chemical leaching, and other stages of use. The construction industry's use of impact crushers is but one example of the need to reduce wear caused by a materials flow in an apparatus used to effect the size of aggregate in the materials flow, to make substantially uniform the size of aggregate in a materials flow, and to prepare materials for further processing.

Generally, impact crushers provide a device for introducing aggregate into a device for crushing the aggregate. Many impact crushers are designed to rely on centrifugal force to disperse large aggregates through the crusher and to impact the aggregate against a wide variety of impact crusher components to break up, reduce in size, and ultimately eject from the crusher, aggregates composed of desired shapes, sizes, and consistency.

Impeller impact crushers may include but are not limited to one impeller table, having a central feed body and impeller shoes attached to an impeller assembly. The shoes, in combination with centrifugal force, hurl and direct an aggregate flow generated by operation of an impeller assembly against one or more anvils located within the crusher. Both the central feed body and impeller shoes on the impact impellers are subjected to substantial wear caused by material flow.

The face of prior art impeller shoes are radially oriented with respect to the central axis of the impact impellers. The impeller shoes change the direction of the material flowing outwardly along the impeller table due to centrifugal force. The accelerating mass of the material applies a substantial force vector normal to the surface of the shoe. The normal force against the surface of the shoe results in high friction and high wear rates of the shoe.

Ackers et al. U.S. Pat. No. 4,090,673 discloses a centrifugal impact rock crusher having a central feed area with a central feed cone. The central feed area is subject to large impact forces that may arise when rock is fed from the central hopper to the centrifugal impact crusher. Feed cones made from a uniform steel alloy as disclosed in U.S. Pat. No. 4,090,673 must be frequently replaced.

Efforts have been devoted to improvements in the design and construction of components of impact crushers to reduce the cost of acquiring and operating crushers, to enhance wear resistance of the component parts of crushers, and to facilitate rapid replacement of worn parts of crushers to enable the user of crushers to lose the least possible amount of time during which a crusher is inoperative due to worn parts.

Such improvements are exemplified by U.S. Pat. No. 5,954,282 issued Sep. 19,1999. The Britzke et al. Patent is instructive on describing how components in an impact crusher are exposed to wear during operation of an impact crusher. All components of an impact crusher exposed to a material flow of aggregate, as exemplified in Britzke et al. U.S. Pat. No. 5,954,282 and other impact crushers, are subject to abrasion, decomposition, fracture, friction, impact, pulsation, wave action, grinding, and other actions causing wear to components of an impact crusher this is due to the velocity, acceleration and composition of aggregate flows against, across, and around the components during operation of a crusher (collectively, “wear”).

U.S. Pat. No. 5,954,282 to Britzke et al. discloses an impeller assembly including wear resistant rods press fit into bores formed in the vertical crusher assembly. Vertical impact crushers such as U.S. Pat. No. 5,954,282 incorporate a flat central feed disc for receiving material from a hopper. The Briztke et al. '282 U.S. patent employs hard material rods that are interference press fit into bores milled into a ferrous body. The hard material used to construct the rods in the Britzke et al. '282 patent has a much greater wear resistance than the ferrous material used to construct the body.

Prior art impact crushers constructed according to the Britzke et al. '282 disclosure have suffered from drawbacks during operation in the field. The hard material rods in Britzke et al. '282 themselves have proven durable in resisting wear but the ferrous material of the body at 12 in Britzke et al. '282 wears out at a predictably accelerated rate in comparison to the rods. As the exposed surface of the ferrous body that fixes and holds the rods recedes the depth of the bores at 24 in Britzke et al. '282 shorten exposing more of the rod. As the body ferrous material recedes, the interference press fit between the ferrous body and rods shorten and weaken until eventually on account of the weakened joint the rods are then easily knocked out by aggregate. In such impeller plates and impeller shoe designs as described in Britzke et al. '282, the press fit compact wear rods on the impeller shoes and center feed disc prematurely become dislodged by aggregate material. In efforts to protect hard material rods from wash out, prior designs have attempted to position adjacent hard material rods closer together, but have been unsuccessful. In these prior designs it was necessary that the spacing between the rods became so small that the strength and integrity of the ferrous body for receiving and holding (interference fit) the insert rods weakened and softened to the point that the interference fit was insufficiently strong to hold the rods in place.

The “washed out” compact rods are slung against the anvil and other components of the crusher by the centrifugal force generated by the rotating impeller. The hard material rods cause damage to the components of the impeller that are often made of softer materials. These compact rods that broke free of the impeller or shoes were hurled against the anvils and other components of the vertical shaft impeller (VSI) causing accelerated wear and greater damage to the VSI as the compact inserts bounce back and are constantly flung within the impeller against anvils and other components. On occasion such compact inserts would knock loose other compact inserts resulting in more destruction and even greater acceleration of damage within the VSI.

Further, such prior art designs as disclosed in the Britzke et al. '282 patent describe the bore for receiving the rods as being formed by drilling, reaming, countersinking or incision by thermal means. To obtain acceptable precision in cutting out the press fit bores within acceptable tolerances requires expensive machinery and equipment.

What is needed, therefore, is a cost effective device for reducing wear of components of apparatus exposed during operation to a material flow. Particularly, what is needed is a device for reducing wear of components of an impact aggregate crusher caused by a material flow of aggregate during operation.

### SUMMARY OF THE INVENTION

An impeller assembly for crushing earth materials such as rock into desirable shapes and sizes. The impeller assembly assists in projecting and directing an aggregate flow against, over or around another embodiment of a body (e.g., anvil) designed for crushing, fracturing, breaking up and reducing in size and shape large aggregate into smaller sizes and shapes.

It is an object of the present invention to provide components having greater resistance to wear on equipment that is exposed to aggregate flow. The present invention is particularly, but not exclusively, useful for reducing wear of component parts of impact crushers caused by earth aggregate flows during operation of impact crushers. The impeller crusher assembly of the present invention when exposed to material flows during operation of the impact crusher will increase the wear life of components by resisting wear caused by a material flow across, over, and around the impact crusher assembly.

In the present invention, the outer end of a first rod made of hard material extends above the surface of an impeller component. The first rod assists in protecting the softer housing material from being worn away by material flow, “washed out”. Each rod in the applicant's invention is positioned in a preselected position to help prevent adjacent rods from being “washed out.”

Compact inserts are embedded and bonded together within a center feed disc body cast from a corrosion resistant metal such as stainless steel. The compact inserts extend outward beyond the top surface of the center feed disc body. The compact inserts are made from a hard material to reduce wear on the surface of the center feed disc.

Likewise compact inserts are embedded and bonded together within a liner made from an impeller shoe body cast from a corrosion resistant metal such as stainless steel. The compact inserts extend outward beyond the top surface of center feed disc body. The compact inserts are made from a hard material to reduce wear on the surface of the center feed disc.

In one embodiment both the center feed body housing and the impeller shoe housing include an upper portion constructed of a protective metallic composite matrix having small cemented carbide particles and impregnated with a plurality of hard material insert rods extending above the top face of the central feed body housing.

The present invention also has longer hard material insert rods positioned about the outer periphery of a central feed body to protect the peripheral surface from wear.

Still, another object of the present invention is to provide a design for reducing wear of components of impact crushers during operation and a method for manufacturing wear reducing components which are easy to manufacture, use and to practice and which are cost effective for their intended purposes.

These and other objects, features, and advantages of such components for reducing wear by a material flow will become apparent to those skilled in the art when read in conjunction with the accompanying following detailed description, drawing figures, and appended claims.

The novel features of this invention and the invention itself, both in structure and operation, are best understood from the accompanying drawing considered in connection with the accompanying description of the drawings.

### BRIEF DESCRIPTION OF THE DRAWINGS

FIG. 1 is a perspective view of a component of an impact crusher machine of the type employing the impeller shoes and conical center feed body of the present invention.

FIG. 2a is a perspective view of an impeller shoe of the present invention incorporated with the impact crusher machine shown in FIG. 1.

FIG. 2b is a rear view of the impeller shoe illustrated in FIG. 2a.

FIG. 2c is a cross sectional view taken along line 2c-2c in FIG. 2a.

FIG. 3 is a top view of a central feed body of the present invention incorporated with the impact crusher machine shown in FIG. 1.

FIG. 4 is a cross-sectional view of the center feed body taken along lines 4-4 in FIG. 3.

FIG. 5 is a second embodiment of the present invention.

### DESCRIPTION OF THE PREFERRED EMBODIMENT

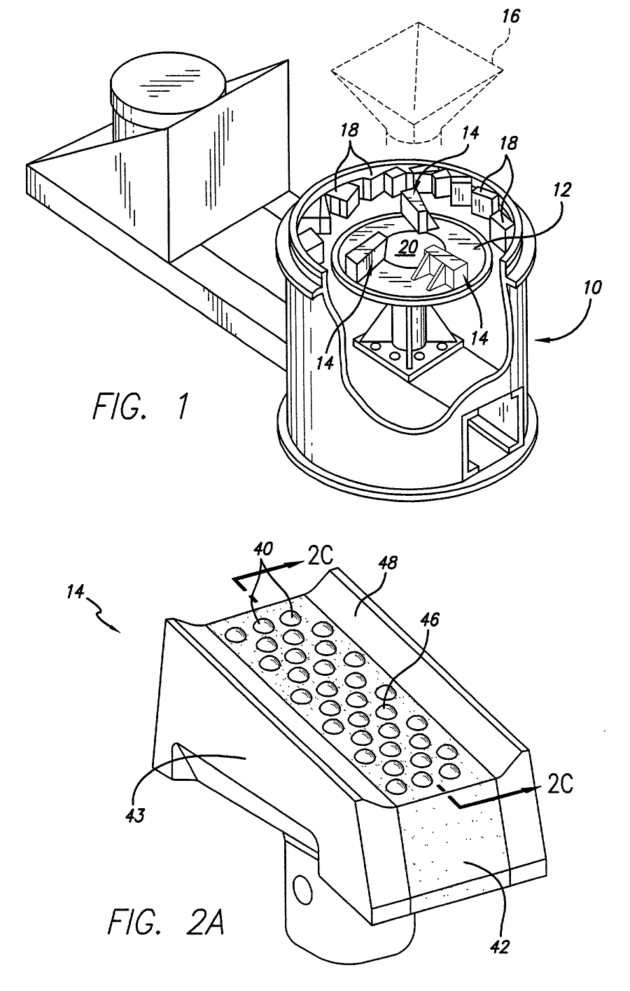

Referring now to FIG. 1, an impact-type rock-crushing machine 10 includes a turntable 12 which revolves at a high speed about a central shaft (not shown). Impeller blade shoes 14 are affixed to the turntable 12 at regular intervals along its surface. Rock or other aggregate (not shown) drops onto the turntable from a funnel 16 located above the turntable, and the centrifugal force caused by the rotating shoes slings the rock outwards causing it to strike a series of anvils 18 and be crushed. Initially the rock or aggregate falls on a central feed body 20 of the turntable 12 but as the turntable is rotating, the rock spreads outward along the central feed body 20 forming streams of material, particulate in nature, which flow across the wear surfaces of each of the impeller blade shoes 14.

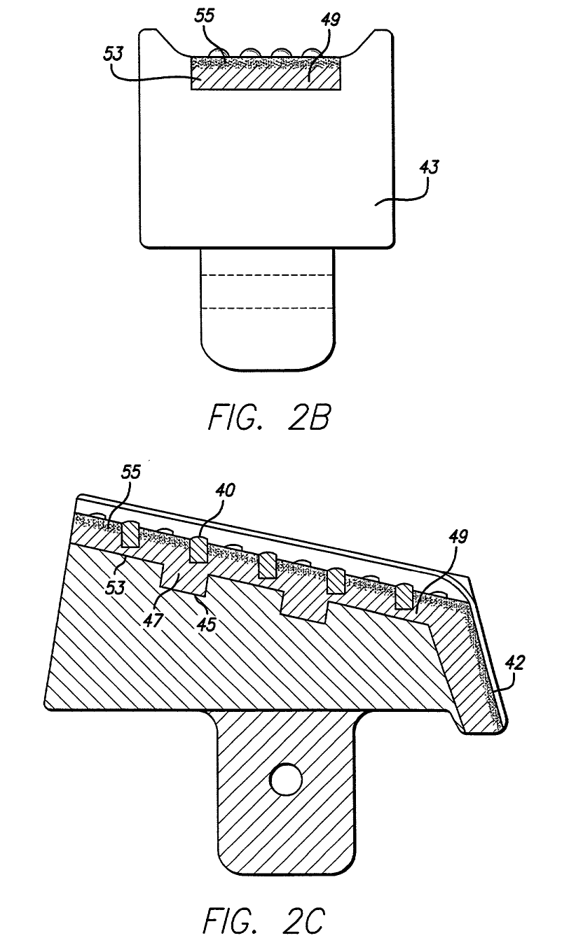

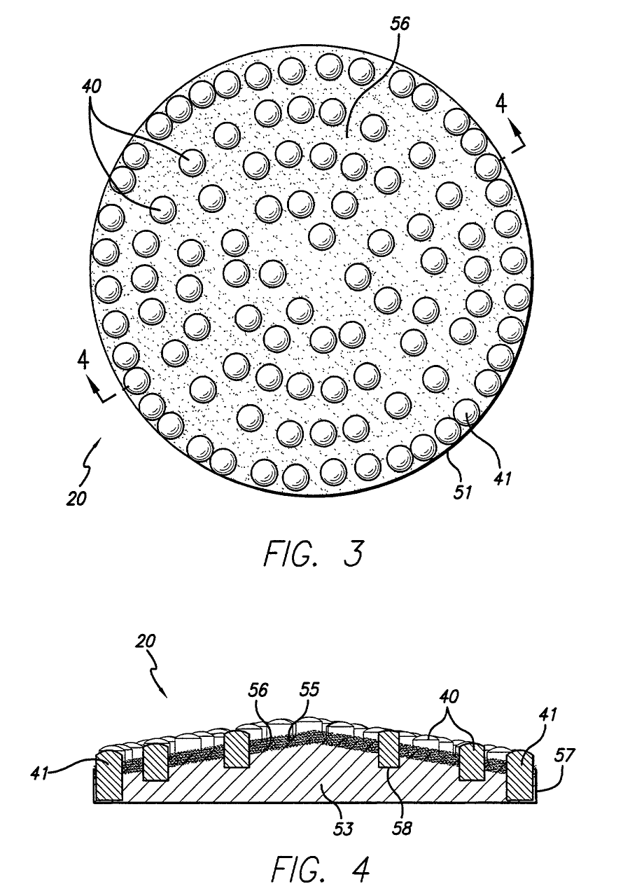

FIGS. 3 and 4 disclose a central feed body 20 and FIGS. 2a-2c disclose an impeller shoe 14. It should be appreciated that the employed materials, general construction and method of making both the impeller shoe 14 and central feed body 20 are applicable to both and also to other components on any and all equipment exposed to aggregate material flow. It is contemplated for instance that the anvils and table plates on the impeller crusher could also be made in accordance with the following description.

FIGS. 3 and 4 best illustrate an upper portion 55 of cemented carbide particles forming a composite matrix providing protection of the central feed body 20.

The embodiment illustrated in FIGS. 3 and 4 illustrate the central feed body housing as being generally conical; however, it is contemplated that the central feed body housing may be a disc, plate, convex or other shape. The central feed body housing comprises of a lower portion 53 and the upper portion 55. The lower portion 53 (just cross-hatched) of the central conical feed body housing is constructed entirely of air hardened steel, an example of an appropriate air hardened steel is described in U.S. Pat. No. 5,279,902 which is hereby incorporated by reference in its entirety, and the upper portion of the central conical feed body housing 55 comprises cemented carbide particles embedded in the same air hardened steel forming a composite matrix such as is disclosed in U.S. Pat. No. 4,024,902. During manufacturing of the central feed body 20 the rods 40 are positioned according to a preselected pattern in the mold, next cemented carbide particles are randomly placed in the mold about the rods in a generally uniform depth, and then a melted alloy is poured into the mold filling the voids between the carbide particles and diffusing therewith to form a cemented carbide particle composite matrix, see U.S. Pat. No. 4,024,902, which is herein incorporated by reference. In the present invention the size of the cemented carbide particles is selected so as to adequately flow into and fill the voids formed between the preselected pattern of the rods 40,41. In one embodiment the grain size of the carbide particles has an ISO mesh size of ¼X-4. The melted alloy used in this invention, is a steel exhibiting acceptable hardness and impact toughness is prepared generally according to standard molten steel casting procedures well known in the art before being poured into the cast mold. In one embodiment an air hardened steel having the following composition is employed: Manganese 1.5%, Nickel 1.5%, Chromium 0.8%, Molybdenum 0.25%, Carbon 0.30%, Silicon 1.5% Maximum), the resulting air hardened steel has a hardness Rc 48-52.

It is contemplated that a material other than cemented carbide may be used for forming the particles. The particles can be made from a ceramic material or other well-known material in the construction industry. However the materials used for the particles must be harder than the alloy used to make the central feed body housing.

In the casting method of the present invention, the proximal ends of the rods 40 are integrally cast into the central feed body housing. The proximal ends of the rods 40 extend downwardly from the top surface 56 of the central conical feed portion into the central conical feed body housing. The circular bottom surface 58 of a single rod is fixed an average depth within the conical central feed housing. The average depth that each of the proximal ends of all the rods 40 are impregnated within the housing in this embodiment is generally uniform. As best shown in FIG. 4, the thickness/depth of the upper portion of the central conical feed body housing 55 is constant and can extend downward to about half the average depth that the rods 40 are each metallurgically bonded within the central conical feed body housing.

The cemented carbide particles in upper portion 55 form a steel alloy composite matrix that significantly reduces the rate at which the housing material holding the rods 40 is eroded or “washed out” by the aggregate materials being crushed. It is contemplated that the depth of the composite matrix 55 can be dimensioned so as to extend downward a sufficient depth so that the rods are completely immersed within the composite matrix providing maximum protection to the integral cast bond between the rods and housing.

Rods 40 of generally uniform size are positioned in a cast mold so as to extend beyond the top surface 56 of the housing a uniform height. In the illustrated embodiment rods 41 are also designed to extend beyond the top surface 56 the same uniform distance that rods 40 extend above the top surface 56.

As discussed above the bottom 58 of uniform rods 40 can be fixed a uniform average depth within the ferrous material of the housing forming equally strong bonds of the rods 40 within the central feed body. Although it is desirable that the average depth that the rods 40 are positioned within the central feed body housing is uniform so that the rods are metallurgically bonded equally well to the housing it is contemplated that the rods 40 may be designed different lengths so as to extend to varying depths below the top surface 56 to protect sections of the central feed body 20 that are known to be subjected to greater material flow than other section of the central feed body 20. Longer rods that are positioned relatively deeper within the central feed body will be more resistant to “wash out” and better able to withstand the greater material flow. These longer rods can be fixed into the central feed body 20 to a depth below the top surface twice that of other rods 40 to protect areas of the central feed body that are subjected to greater material flow.

The distal end of all the rods 40 and 41 are designed to be positioned within the central feed body so as to extend an equal height above the top surface 56. It should be noted that the rods 40,41 are positioned to extend an equal amount above the top surface 56 so that none of the rods will extend above the top surface 56 more than the other rods 40,41. If one rod projected above the other rods it would be subjected to greater material flow exposure than the other rods 40,41.

The capacity of central feed body 20, according to the present invention, to reduce wear caused by a material flow is not solely affected by the distance the distal end extends of the rod extend above the top surface 56 and the depth of the composite matrix. The effectiveness of central feed body 20, according to the present invention, to reduce wear by a material flow, is a function in part of the distance the distal end extends above the top surface 56, as well as the design, shape, spacing, configuration and location of the rods on the central feed body 20 in relation to angles of incidence of a material flow against, over and around central feed body, and the alloy composition of rod 44 the composition and depth of the composite matrix forming the upper portion of the housing 55.

At least some of the circumference rods 41 located about the circumference of the central feed body as shown in FIG. 4 extend to close to the bottom surface of the central feed body. The circumference rods 41 are intentionally designed to have an extended length to protect the circumferential sidewall 57 of the central feed body from wearing at an accelerated rate. The circumferential sidewall 57 of the central feed body is subjected to significant material flow abrasion and impact caused by material rebounding off anvils back toward the circumferential sidewall 57. The long rods 41 are effective in protecting accelerated wear about the circumferential sidewall 57. Although not shown in FIG. 4 it is contemplated that a cemented carbide particle composite matrix could also be employed to protect the exposed peripheral sidewall 57.

The impeller shoe 14 illustrated in FIGS. 2a-2c according to the present invention, includes at least one first surface 46 exposed to a material flow during operation of the apparatus. As will be evident from one skilled in the art, impeller shoe 14 may have more than one surface which, during operation, that is exposed to a material flow for example front face 42 on the impeller shoe is also exposed to material flow. The darkened grit surfaces in FIGS. 2a-2c on the impeller shoe represent cemented carbides particles integrally embedded in a separately constructed wear resistant shield 49. The wear resistant shield 49 is made from a steel alloy having cemented tungsten carbide particles integrally embedded within the exposed surfaces a uniform depth. The uniform depth of the particles is between about 0.125″-0.5″, in one embodiment it is contemplated that the generally uniform depth of the cemented carbide particles is about ¼″. A well-known suitable selection of cemented carbide particles embedded in a steel alloy forming composite matrix are sold under the trademark KENCAST™, by Kennametal Inc., having a place of business at 1600 Technology Way, P.O. Box 231, Latrobe, Pa. 15650. U.S. Pat. Nos. 4,017,480; 4,024,902; 4,146,080 and 4,140,170, to Baum, each discloses a suitable cemented carbide embedded in an alloy and a process for making such a composite matrix. U.S. Pat. Nos. 4,017,480; 4,024,902; 4,146,080 and 4,140,170, to Baum, are all hereby incorporated by reference in their entirety.

In addition, the first surface 46 of the wear shield includes a plurality of larger hard material insert means. In the illustrated embodiments, the larger hard material insert means are represented by hard material compact rods 40,41. The wear shield 49 according to the present invention includes at least one hard material compact rod 40 having a generally cylindrical shape. Rod 40 has a distal end and a proximal end. The proximal end of the inner rods 40 can be cast between about 0.5-1.5 inches deep into the housing of the shoe 14. In the central feed body embodiment illustrated in FIG. 4, the rods 40 (not 41) are cast 0.5″ beneath the first surface 56.

The wear shield 49 is attached to shoe housing 43 by fastening means such as welding, epoxy, tongue-groove, bolts or other by using other methods well known in the art. As shown in FIG. 2c the shield 49 is properly located into position on the shoe housing 43 by keys 47 that are received in cooperating sockets 45 in the shoe housing. In addition to locating the shield 49 onto the shoe housing 43 the cooperating keys and sockets assist in fixing the shield to the shoe housing 43. The shield 49 is shaped and designed to protect surface areas of highest wear concentration. Once the shield 49 is worn away by material flow it can be removed from the shoe housing and replaced with a new shield 49.

The shoe housing 43 described above can be made from “white iron.” In the crusher industry, the term “white iron” is used to identify a commonly used alloy of chromium and iron consisting essentially of 27% chromium with the balance in iron and trace materials. The chromium content can vary from between 25%-29%. Other well-known wear resistant alloys in the construction industry could alternatively be used to manufacture the shoe housing 43.

The rods 40 and 41 are constructed from a hard material such as a carbide or other hard material composition having wear resistant properties greater than “white iron”. The rods 40 and 41 may be manufactured by powder metallurgy techniques. However, manufacture of one or more rods 40/41 by powder metallurgy techniques is merely one embodiment of rod 40/41 in connection with the present invention, it is not intended to be exclusive, and is not a limitation of the present invention. Rods 40 may be manufactured by combining a powder such as tungsten carbide with a binder such as cobalt, nickel or other similar chemical compositions. The powder and binder may be blended and compacted in a press or similar device. For some applications the rods can be made of a highly wear resistant cemented tungsten carbide as disclosed in U.S. Pat. No. 4,859,593, to Greenfield et al. U.S. Pat. No. 4,859,593, to Greenfield et al., is herby incorporated into the specification in its entirety. In a preferred embodiment of the invention the hard material insert means are a cemented tungsten carbide 6% Cobalt, with properties of 89.9 HRA, 14.95 gm/cc density, 1-10 micron grain size, 100 Oe and 13.20 MPa m^{1/2} K1C fracture toughness.

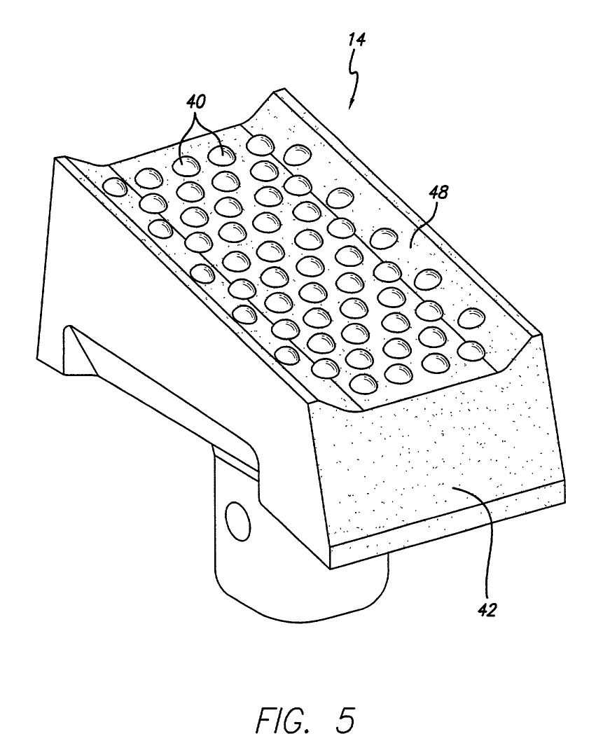

In another embodiment shown in FIG. 5 the impeller shoe is cast as one integral piece unlike the embodiment illustrated in FIGS. 2a-2c which comprises of two separately assembled pieces, the shield 49 and body 43. The impeller shoe shown in FIG. 5 is made in a manner more similar to the central feed body illustrated in FIGS. 3 and 4. During construction the rods 40 are positioned according to a preselected pattern in the impeller shoe mold, next carbide particles are randomly placed about the rods at a uniform depth, and then a melted alloy is poured into the mold filling the voids between the carbide particles and diffusing therewith to form a cemented carbide particle composite matrix, see U.S. Pat. No. 4,024,902, which is herein incorporated by reference. The shaded area in FIG. 5 represents areas having embedded carbide particles. In this embodiment the cemented carbide composite matrix also protects the surface area of the side rails 48 and the complete front face 42 of the impeller shoe. The impeller shoe illustrated in FIG. 5, like central feed body 20 discussed above, may be made of air hardened steel as described in U.S. Pat. No. 5,279,902, or other suitable steel alloy having desirable wear characteristics.

The rod patterns depicted in FIGS. 2-5 are merely representative of a rod pattern for a crusher and to help disclose the present invention, and are not intended to limit the scope of application of the present invention. Also in FIGS. 2-5, the distal exterior end of the rods 40 is rounded or hemispherical. However, as will be evident to one skilled in the art, the shape of the distal end of rod is not a limitation on this invention. Further, it should be noted that the larger hard material insert means are not intended to be limited to being generally cylindrical shaped rods, but may be rectangular bars, bullet shaped, hexagonal other geometrical shapes. Nor do all the geometrical shapes have to be the same, but a variety of mixed shapes and sizes could be employed.

The novel features of this invention and the invention itself, both in structure and operation, are best understood from the accompanying drawings considered in connection with the accompanying description. It should be noted that the illustrated embodiments and corresponding description are merely one of many designs for the invention and merely representative of an application of the invention for an impeller rock crusher. It is contemplated for instance that the disclosed invention would also have application for not just the open impeller system described above, but also for closed impeller systems. The invention is not intended to be limited to the disclosed embodiments and description herein.

What is claimed is:

1. An impeller for hurling aggregate material toward anvils said impeller comprising:
a central feed body housing,
wherein said center feed body housing includes a top surface and a plurality of hard material insert means integrally fixed within said housing in a preselected pattern.

2. The impeller according to claim 1 wherein said central feed body housing includes a lower portion and an upper portion.

3. The impeller according to claim 2 wherein said upper portion has particles embedded therein for protecting said plurality of hard material insert means from being prematurely displaced.

4. The impeller according to claim 3 wherein said particles are made from cemented tungsten carbide.

5. The impeller according to claim 4 wherein said housing is constructed from air hardened steel.

6. The impeller according to claim 3 wherein said particles are distributed to form a generally uniform depth of particles below said top surface.

7. The impeller according to claim 6 wherein said hard material insert means extend downwardly an average depth below said top surface.

8. The impeller according to claim 7 wherein said particles extend downwardly below said top surface to a depth of about half said average depth of said hard material insert means.

9. The impeller according to claim 7 wherein said depth of said particles is generally uniform and is between 0.125″-0.5″.

10. The impeller according to claim 9 wherein said generally uniform depth of said particles is 0.25″.

11. The impeller according to claim 7 wherein said average depth below said top surface is between about 0.5″-1.5″.

12. The impeller according to claim 7 wherein said average depth the hard material insert means extend below said top surface varies to better protect sections of said central feed body subjected to greater material flow.

13. The impeller according to claim 1 wherein said central feed body housing includes a circumference sidewall, said plurality of hard material insert means includes circumference hard material insert means for protecting said circumference sidewall.

14. The impeller according to claim 7 wherein said hard material insert means are generally rod shaped with a rounded distal end.

15. The impeller according to claim 1 further comprising:
a shoe having a plurality of hard material insert means,
both said shoe and said central feed body each have an upper portion and lower portion wherein said upper portions have particles embedded therein for protecting said plurality of hard material insert means from being prematurely displaced..

16. The impeller according to claim 15 wherein said particles are made from cemented tungsten carbide.

17. The impeller according to claim 16 wherein said hard material insert means extend downwardly an average depth below said top surface.

18. The impeller according to claim 17 wherein said average depth the hard material insert means extend below said top surface varies to better protect sections of said central feed body subjected to greater material flow.

19. An impeller for hurling aggregate material toward anvils said impeller comprising:
a shoe comprising a shoe housing and shield,
said shield having a plurality of hard material insert means,
wherein said shoe housing and said shield are fixed together by fastening means.

20. The impeller according to claim 19 wherein said shield includes an upper portion, lower portion and top surface, wherein said plurality of hard material insert means are fixed within said upper portion in a preselected pattern.

21. The impeller according to claim 20 wherein said upper portion has particles embedded therein for protecting said plurality of hard material insert means from being prematurely displaced.

22. The impeller according to claim 21 wherein said hard material insert means extend downwardly an average depth below said top surface.

23. The impeller according to claim 22 wherein said average depth the hard material insert means extend below said top surface varies to better protect sections of said central feed body subjected to greater material flow.

24. The impeller according to claim 22 wherein said shoe housing is made from white iron and said depth that said particles extend below said top surface is generally uniform and between 0.125″-0.5″.

25. A wear resistant component comprising:
a housing,
wherein said housing includes a top surface and a plurality of hard material insert means metallurgically bonded within said housing in a preselected pattern..

26. The component according to claim 25 wherein said housing includes a lower portion and an upper portion.

27. The component according to claim 26 wherein said upper portion has particles embedded therein for protecting said plurality of hard material insert means from being prematurely displaced.

28. The component according to claim 27 wherein said depth of said particles below said top surface is between 0.125″-0.5″.

29. The component according to claim 28 wherein said hard material insert means extend downwardly an average depth below said top surface.

30. The impeller according to claim 29 wherein said average depth the hard material insert means extend below said top surface varies to better protect sections of said central feed body subjected to greater material flow.

31. The component according to claim 28 wherein said component is an impeller shoe.

32. The component according to claim 28 wherein said component is a central feed body.

33. A method of making a wear resistant component comprising:
positioning in a cast mold a plurality of hard material insert means in a preselected pattern, distributing particles about the hard material means then pouring a melted alloy into said cast mold filling the voids between said particles to form a composite matrix about said particles and allowing the component to cool and solidify to cause the combination of said hard material insert means, said particles and alloy to produce said shield.

34. The method of making a wear resistant component according to claim 33 wherein said particles are cemented tungsten carbide and said melted alloy is air hardened steel.

35. A method of making an impeller shoe comprising:
making a shield by positioning in a cast mold a plurality of hard material insert means in a preselected pattern, distributing particles about the hard material insert means then pouring a melted alloy into said cast mold filling the voids between said particles to form a composite matrix about said particles and allowing the component to cool and solidify to cause the combination of said hard material insert means, said particles and alloy to produce said shield;
fixing said shield to a shoe housing with fastening means.

36. The method of making an impeller shoe according to claim 34 wherein said shoe housing is made from white iron.

37. The method of making an impeller shoe according to claim 36 wherein said particles are made from cemented tungsten carbide.

38. An impeller shoe manufactured by a process in accordance with steps set forth in claim 37.

39. A wear resistant component manufactured by a process in accordance with steps set forth in claim 34.

40. A wear resistant shield comprising:
a lower portion and upper portion,
wherein said upper portion has particles embedded therein for protecting a plurality of hard material insert means.
